(19) United States
(12) Patent Application Publication
(10) Pub. No.: US 2023/0236905 A1
(43) Pub. Date: Jul. 27, 2023

(54) LOCKING AND SYNCHRONIZATION FOR HIERARCHICAL RESOURCE RESERVATION IN A DATA CENTER

(71) Applicant: VMWARE, INC., Palo Alto, CA (US)

(72) Inventors: Raja Shekar CHELUR, Cary, NC (US); Sirish Kumar Bangalore RENUKUMAR, Bangalore (IN); Ianislav TRENDAFILOV, Sofia (BG); Ralitsa Todorova TSANOVA, Sofia (BG); Todor Kostadinov TODOROV, Sofia (BG)

(21) Appl. No.: 17/709,469

(22) Filed: Mar. 31, 2022

(30) Foreign Application Priority Data
Jan. 21, 2022 (IN) 202241003641

(51) Int. Cl. G06F 9/52; G06F 9/50

(52) U.S. Cl. CPC G06F 9/52; G06F 9/505; G06F 9/5038; G06F 9/5061

(57) ABSTRACT

An example method of reserving a resource of virtualized infrastructure in a data center on behalf of a client includes: obtaining, by a resource lock manager from a topology manager, a sub-topology for the resource from a resource topology of the virtualized infrastructure; setting, by the resource lock manager, an exclusive lock on the resource and on each of at least one descendant in the sub-topology for the resource, each exclusive lock disallowing any other lock on its respective resource; setting, by the resource lock manager, a limited lock on each ancestor in the sub-topology for the resource, each limited lock allowing any other limited lock on its respective resource; and notifying the client that a reservation of the resource is granted.

### RELATED APPLICATION

Benefit is claimed under 35 U.S.C. 119(a)-(d) to Foreign Application Serial No. 202241003641 filed in India entitled “LOCKING AND SYNCHRONIZATION FOR HIERARCHICAL RESOURCE RESERVATION IN A DATA CENTER”, on Jan. 21, 2022, by VMware. Inc., which is herein incorporated in its entirety by reference for all purposes.

Modern applications can be deployed in a multi-cloud cloud fashion, that is, consuming both cloud services executing in a public cloud and local services executing in a private data center. Within the public cloud and private data center, applications are deployed onto a combination of virtual machines (VMs), containers, application services, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs.

Cloud management software can be deployed, in a private data center and/or as a cloud service in a public cloud, to implement a higher-level automation system. Users of a private cloud or tenants of a public cloud submit requests to the cloud management software for infrastructure to grow, shrink, or be modified in some fashion. The cloud management software executes workflows in response to these requests. Since the cloud management software can receive multiple requests concurrently, the software implements resource reservation to disallow conflicting operations. One technique is for the cloud management software to reserve the entire system for each workflow. The system resources are locked for use by a particular workflow. Other workflows cannot be started until the system-wide reservation is released. This type of reservation system is not scalable to handle dynamic environments and can result in inefficient handling of workflows.

### SUMMARY

One or more embodiments provide a method of reserving a resource of virtualized infrastructure in a data center on behalf of a client. The method includes: obtaining, by a resource lock manager from a topology manager, a sub-topology for the resource from a resource topology of the virtualized infrastructure; setting, by the resource lock manager, an exclusive lock on the resource and on each of at least one descendant in the sub-topology for the resource, each exclusive lock disallowing any other lock on its respective resource; setting, by the resource lock manager, a limited lock on each ancestor in the sub-topology for the resource, each limited lock allowing any other limited lock on its respective resource; and_notifying the client that a reservation of the resource is granted.

One or more embodiments provide a method of executing a workflow on a resource of virtualized infrastructure in a data center on behalf of a client. The method includes: receiving, from the client at a resource lock manager, a request for a reservation of the resource; setting, by the resource lock manager in response to the request, at least one exclusive lock and at least one limited lock on resources of the virtualized infrastructure, each exclusive lock disallowing any other lock on its respective resource, each limited lock allowing any other limited lock on its respective resource;_notifying, the client by the resource lock manager, that the reservation is granted;_executing, by the client, one or more operations of the workflow; and removing, by the resource lock manager, the at least one exclusive lock and the at least one limited lock in response to a request for a release of the reservation of the resource.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1A is a block diagram of a multi-cloud computing system in which embodiments described herein may be implemented.

FIG. 1B is a block diagram depicting a virtualized infrastructure according to an embodiment.

FIG. 2 is a block diagram depicting logical relation of SDDC manager components according to an embodiment.

FIG. 3 is a flow diagram depicting a method of updating a resource topology according to an embodiment.

FIGS. 4A-4B show a flow diagram depicting a method of executing a workflow by a cloud management system according to an embodiment.

FIG. 5A is a block diagram depicting a resource topology during a workflow operation according to an embodiment.

FIG. 5B is a block diagram depicting the resource topology of FIG. 5A during two concurrent workflow operations according to an embodiment.

### DETAILED DESCRIPTION

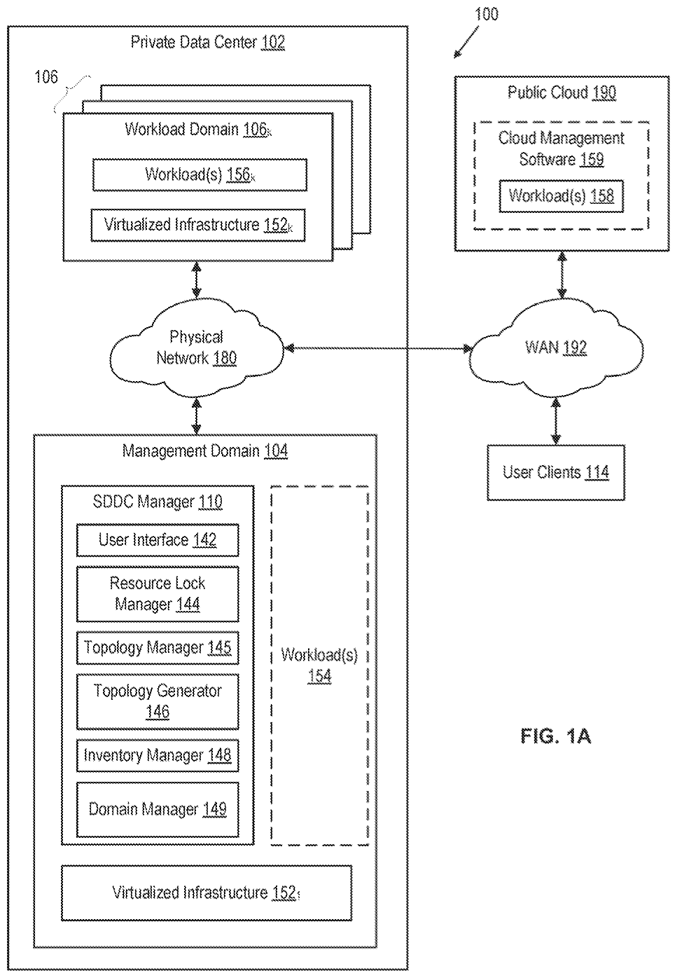

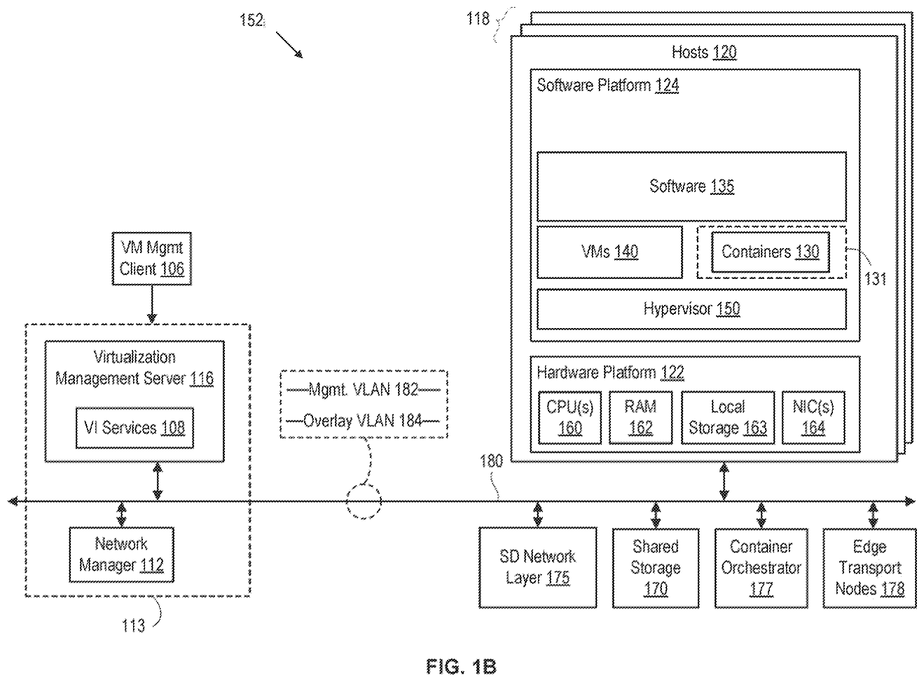

FIG. 1A is a block diagram of a multi-cloud computing system 100 in which embodiments described herein may be implemented. Multi-cloud computing system 100 includes private data center 102 in communication with a public cloud 190. In embodiments, private data center 102 can be controlled and administered by a particular enterprise or business organization, while public cloud 190 is operated by a cloud computing service provider and exposed as a service available to account holders (“tenants”). The operator of private data center 102 can be a tenant of public cloud 190 along with a multitude of other tenants. Private data center 102 is also known as an on-premises data center, on-premises cloud, or private cloud. Multi-cloud system 100 is also known as a hybrid cloud system. In other embodiments, multi-cloud system 100 can be private-private, public-public, or any combination thereof of private and public clouds.

Private data center 102 includes virtualized infrastructure 152 comprising servers (e.g., disposed in racks) and physical network devices (e.g., top-of-rack (TOR) switches, routers, cabling, etc.). The servers have virtualization software installed thereon and are referred to as “hosts.” Private data center 102 include cloud management software installed on virtualized infrastructure 152. The cloud management software provides automated deployment and lifecycle management of private data center 102 as a software-defined data center (SDDC). The cloud management software enables provisioning of virtualized workloads (in virtual machines (VMs) and/or containers) in private data center 102 and the migration of workloads between private data center 102 and public cloud 190. The cloud management software includes a management domain 104 and one or more workload domains 106 (e.g., workload domain 106ₖ is shown in detail).

Management domain 104 includes an SDDC manager 110 provisioned on a portion of virtualized infrastructure 152 (“virtualized infrastructure 152₁). For example, SDDC manager 110 can execute in VMs and/or containers of one or more hosts. In some embodiments, a user can provision workloads 154 on virtualized infrastructure 152₁ alongside SDDC manager 110. Workloads 154 can be any application software executing in VMs and/or containers of one or more hosts. In other embodiments, virtualized infrastructure 152₁ is dedicated for use with SDDC manager 110 and workloads 154 are omitted. Each workload domain 106 includes a portion of virtualized infrastructure 152 (e.g., virtualized infrastructure 152ₖ for workload domain 106ₖ) and workload(s) executing thereon (e.g., workloads 156ₖ for workload domain 106). The workloads in each workload domain 106 can be any application software executing in VMs and/or containers of one or more hosts. A user can provision or migrate some workload(s) 158 to public cloud 190.

The hosts of virtualized infrastructure 152 are connected by physical network 180. Physical network 180 is connected to a wide area network (WAN) 192, such as the public Internet. Private data center 102 communicates with public cloud 190 over WAN 192. Users can access software executing in private data center 102 and public cloud 190 through WAN 192 using user clients 114 (e.g., computers, mobile devices, etc.).

In embodiments, a tenant of public cloud 190 consumes cloud management software 159 as a service of public cloud 190. Public cloud 190 includes virtualized infrastructure that is the same or similar to that of private data center 102 and cloud management software 159 functions the same or similar to how it functions in private data center 102. For purposes of clarity by example, resource reservation techniques of the cloud management software are described with respect to use in private data center 102. However, the techniques are equally applicable to use in public cloud 190 or any data center having virtualized infrastructure in general. Also, while a multi-cloud system is shown, the cloud management system can be deployed in a single data center system.

FIG. 1B is a block diagram depicting virtualized infrastructure 152ᵢ according to an embodiment. Virtualized infrastructure 152ᵢ can be part of a domain, such as management domain 104 (e.g., virtualized infrastructure 152₁) or a workload domain 106 (e.g., virtualized infrastructure 152). Virtualized infrastructure 152ᵢ includes hosts 120 that may be constructed on server-grade hardware platforms such as x86 architecture platforms. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Hosts 120 can be in a single cluster 118 or logically divided into a plurality of clusters 118.

Hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN), which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, Calif. Software 135 executes in VMs 140 and/or containers 130.

Hosts 120 are configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized infrastructure 152ᵢ includes edge transport nodes 178 that provide an interface of hosts 120 to WAN 192. Edge transport nodes 178 can include a gateway between the internal logical networking of hosts 120 and the external network. Edge transport nodes 178 can be physical servers or VMs.

Virtualization management server 116 is a physical or virtual server that manages hosts 120 and the virtualization layers therein. Virtualization management server 116 installs agent(s) in hypervisor 150 to add a host 120 as a managed entity. Virtualization management server 116 logically groups hosts 120 into cluster(s) 118 to provide cluster-level functions to hosts 120, such as VM migration between hosts 120 (e.g., for load balancing), distributed power management, dynamic VM placement according to affinity and anti-affinity rules, and high-availability. The number of hosts 120 in each cluster 118 may be one or many.

In an embodiment, multi-cloud computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. In this manner, a cluster 118 can be a cluster of transport nodes. One example of an SD networking platform that can be configured and used in embodiments described herein as network manager 112 and SD network layer 175 is a VMware NSX® platform made commercially available by VMware. Inc. of Palo Alto, Calif. In some embodiments, one or more of workload domains 106 can share an instance of network manager 112. Thus, network manager 112 may be omitted from virtualized infrastructure 152ᵢ for some domains.

Physical network 180 can be divided into multiple virtual local area networks (VLANs), such as a management VLAN 182 and an overlay VLAN 184. Management VLAN 182 enables a management network connecting hosts 120, VI control plane 113 (e.g., virtualization management server 116 and network manager 112), and SDDC manager 110. Overlay VLAN 184 enables an overlay network that spans a set of hosts 120 (e.g., cluster 118) and provides internal network virtualization using software components (e.g., the virtualization layer and services executing in VMs). Host-to-host traffic for the overlay transport zone is carried by physical network 180 on the overlay VLAN 184 using layer-2-over-layer-3 tunnels. Network manager 112 can configure SD network layer 175 to provide a cluster network for each cluster 118 using the overlay network. The overlay transport zone can be extended into at least one of edge transport nodes 178 to provide ingress/egress between a cluster network and an external network.

Virtualization management server 116 and network manager 112 comprise a virtual infrastructure (VI) control plane 113 of virtualized infrastructure 152i. Virtualization management server 116 can include various VI services 108. VI services 108 include various virtualization management services, such as a distributed resource scheduler (DRS), high-availability (HA) service, single sign-on (SSO) service, virtualization management daemon, and the like. An SSO service, for example, can include a security token service, administration server, directory service, identity management service, and the like configured to implement an SSO platform for authenticating users.

In embodiments, virtualized infrastructure 152ᵢ can include a container orchestrator 177. Container orchestrator 177 implements an orchestration control plane, such as Kubernetes®, to deploy and manage applications or services thereof on host cluster 118 using containers 130. In embodiments, hypervisor 150 can support containers 130 executing directly thereon. In other embodiments, containers 130 are deployed in VMs 140 or in specialized VMs referred to as “pod VMs 131.” A pod VM 131 is a VM that includes a kernel and container engine that supports execution of containers, as well as an agent (referred to as a pod VM agent) that cooperates with a controller executing in hypervisor 150 (referred to as a pod VM controller). Container orchestrator 177 can include one or more master servers configured to command and configure pod VM controllers in host cluster 118. Master server(s) can be physical computers attached to network 180 or VMs 140 in a cluster 118.

Returning to FIG. 1A. SDDC manager 110 includes a user interface 142, a resource lock manager 144, a topology manager 145, a topology generator 146, an inventory manager 148, and a domain manager 149. SDDC manager 110 receives requests from users through user interface 142 and domain manager 149 executes workflows in response to the requests. User interface 142 can also include an application programming interface (API) for use by software to access SDDC manager 110. Requests can be, for example, requests to create, update, or destroy, resources of virtualized infrastructure 152. In some cases, external software can provide workflows to SDDC manager 110 through user interface 142 for operations on virtualized infrastructure 152. SDDC manager 110 is configured to allow operations on resources of virtualized infrastructure 152 without preventing operations on other resources. SDDC manager 110 disallows a resource of virtualized infrastructure 152 from being modified or deleted if another operation is currently operating on that resource.

A resource of virtualized infrastructure 152 is a component of physical or logical infrastructure. A resource can be a single host, a cluster of hosts, an appliance (e.g., virtualization management server 116, network manager 112, edge transport nodes 178), or a domain (e.g., management domain 104 or a workload domain 106). A resource graph is a hierarchy of resources in virtualized infrastructure 152. Resources can be in parent/child relationships or other relationships (e.g., depends on). For example, a host can be a child of a cluster, which in turn can be a child of a domain, which in turn can be a child of the cloud management instance (root). A workflow is a user-initiated or software-initiated operation on virtualized infrastructure 152. Workflows include create, update, destroy, and other types of mutative operations on resources. Examples include creating a workload domain, creating a cluster, commissioning or decommissioning a host, rotating passwords, or the like. Each workflow has a resource against which it is initiated. A workflow can have one or more operations executed against a member resource. For example, a password rotate operation can be initiated against a cluster, but the operation is performed one host at a time. Workflows can be internal to SDDC manager 110 (e.g., a user makes a request and SDDC manager 110 starts a workflow) or external to SDDC manager 110 (e.g., external software provides operations to be performed against resources).

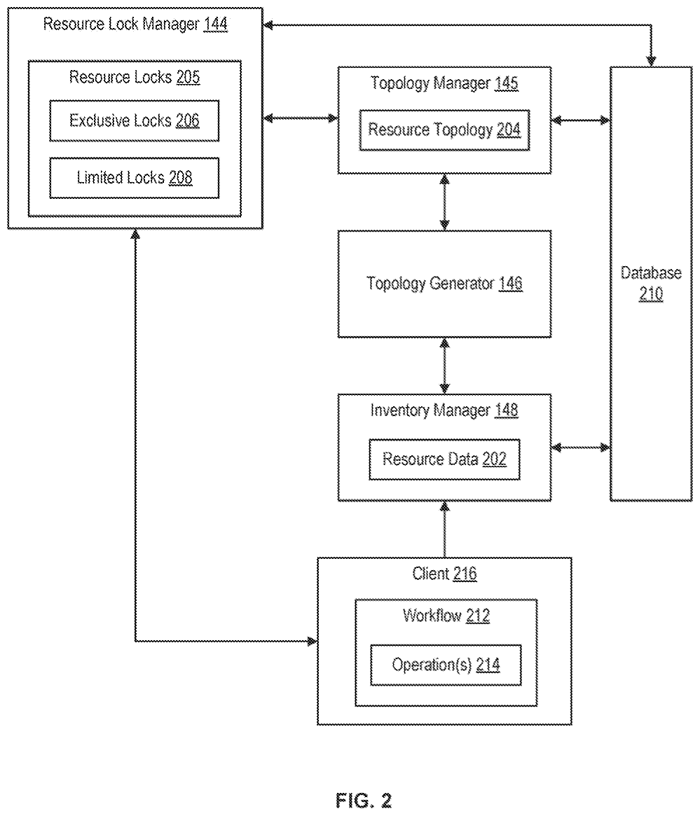

FIG. 2 is a block diagram depicting logical relation of SDDC manager components according to an embodiment. Inventory manager 148 maintains resource data 202 for virtualized infrastructure 152. A client 216 initiates a workflow 212, which includes one or more operations 214 to be performed on resource(s) of virtualized infrastructure 152. Client 216 can be a component of SDDC manager 110 (e.g., domain manager 149) or external software. Workflows that create, update, or destroy the resources cooperate with inventory manager 148 to persist, update, and remove resources based on resource identifiers. Inventory manager 148 stores resource data 202 in a plurality of tables, such as a cluster table for cluster resources, a cluster-and-host table that relates cluster and host resources, a host table for host resources, a cluster-and-domain table that relates cluster and domain resources, and the like. In FIG. 2, the data generated by SDDC manager 110 is shown with the respective components for clarity. In embodiments, the components can store their respective data in database 210 (e.g., resource locks 205, resource topology 204, and resource data 202).

Topology manager 145 maintains a resource topology 204 for virtualized infrastructure 152. For topology manager 145, a resource is represented by its identifier. Each resource can have the following relationships with other resource(s): (1) a resource can have zero or more child resources; (2) a resource can have zero or more associated resources; and (3) a resource has one parent resource. For example, a cluster resource can have a plurality of child host resources. A domain resource can have one or more child cluster resources. A domain resource can have associated network manager and virtualization management server resources. A domain resource's parent is the cloud management software instance (the root resource). A cluster resource's parent is a domain resource. Topology manager 145 is agnostic to resource specification and can track resource topology for any types of resources.

Topology manager 145 includes application programming interfaces (APIs) that allow initial generation of resource topology 204 and then updating of resource topology 204 by adding or removing resource nodes. In embodiments, topology manager 145 includes an API for adding a resource node to resource topology 204 (“add resource API”). The add resource API takes as parametric input an identifier for the resource being added, an identifier of the parent resource, and identifier(s) of associated resource(s) if any. Topology manager 145 includes an API for removing a resource node from resource topology 204 (“remove resource API”). The remove resource API takes as parametric input an identifier of a resource to be removed. As part of removal, the resource and its descendants are removed from resource topology 204. The relationships with associated resources are also removed (if any). If there are zero relationships left with an associated resource, then the associated resource is also removed. Parent-child relationship between the parent and the resource node being removed are also deleted. Topology manager 145 includes an API for retrieving the entire resource topology (“retrieve resource topology API”). Topology manager 145 includes an API for retrieving a sub-topology (“retrieve resource sub-topology”). The retrieve resource sub-topology API takes as parametric input a resource identifier. The sub-topology includes the resource, its ancestors, and its descendants.

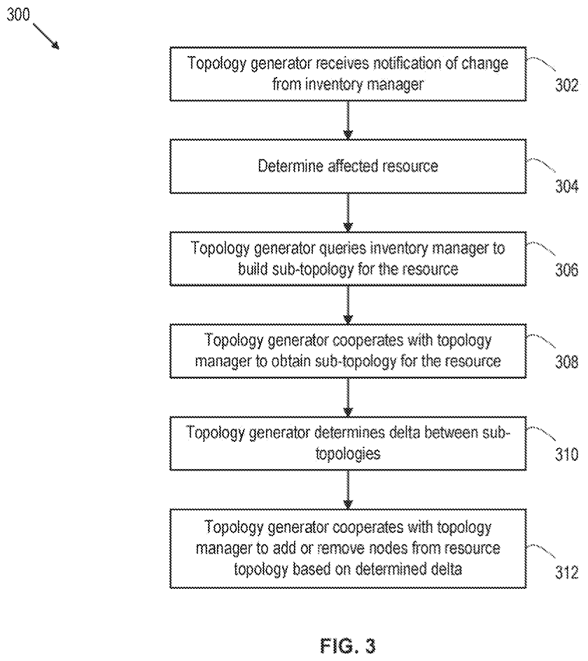

Inventory manager 148 is configured to notify topology generator 146 each time a workflow changes the resource data. FIG. 3 is a flow diagram depicting a method 300 of updating a resource topology according to an embodiment. Method 300 begins at step 302, where topology generator 146 receives a notification of change in resource data 202 from inventory manager 148. Such a change can be caused by execution of workflow 212 that updates resource data 202 (e.g., add resource(s), update resource(s), destroy resource(s)). At step 304, topology generator 146 determines a resource affected by the change in the resource data. Inventory manager 148 can provide an identifier of the affected resource in the notification.

At step 306, topology generator 146 queries inventory manager 148 to obtain the descendants, ancestors, and associated resources (if any) for the affected resource. Topology generator 146 builds a sub-topology for the resource. At step 308, topology generator 146 cooperates with topology manager 145 to obtain a sub-topology for the affected resource. Topology generator 146 can call the retrieve resource sub-topology API of topology manager 145. At step 310, topology generator 146 determines the delta between the sub-topology built from resource data 202 of inventory manager 148 and the sub-topology retrieved from topology manager 145. At step 312, topology generator 146 cooperates with topology manager 145 to add/remove nodes from resource topology 204 based on the determined delta. Topology generator 146 can call add resource API or remove resource API as needed to make resource topology 204 consistent with resource data 202 managed by inventory manager 148.

Returning to FIG. 2, resource lock manager 144 is configured to reserve and release resources on behalf of client 216. Client 216 first cooperates with resource lock manager 144 to request a resource reservation. Upon receiving a reservation request, resource lock manager 144 cooperates with topology manager 145 to obtain a sub-topology for the resource. Resource lock manager 144 can then identify all the affected resources from the sub-topology and make the appropriate reservations. Resource lock manager 144 supports reservation and release of resources without depending on resource type.

Resource lock manager 144 reserves resources in a granular manner. In embodiments, resource lock manager 144 reserves resources by asserting resource locks 205 against the resources. Resource lock manager 144 can use two different types of locks, namely, exclusive locks 206 and limited locks 208. These different types of locks are only known internally to resource lock manager 144 and are not exposed to client 216. When client 216 requests a reservation of a resource, resource lock manager 144 will assert an exclusive lock against 206 against that resource. Other resources in the sub-topology can have either exclusive locks 206 or limited locks 208 based on a set of rules. In an embodiment, resource lock manager 144 enforces the following rules with respect to applying resource locks 205: (1) A resource that already has a limited lock can have another limited lock. (2) A resource that already has a limited lock cannot have another exclusive lock by a different client. If a client has reserved a resource X and resource lock manager 144 has asserted a limited lock against resource Y, then that same client (but not another client) can take an exclusive lock on resource Y. (3) A resource that already has an exclusive lock cannot have another limited lock. (4) A resource that already has an exclusive lock cannot have another exclusive lock. (5) A resource that does not have a limited lock can have a limited lock or an exclusive lock.

Resource lock manager 144 identifies which other resources should be reserved when a resource reservation is requested by client 216. These additional resources are identified based on the resource sub-topology obtained from topology manager 145. The sub-topology can include ancestor(s), descendant(s), and associated resource(s). Based on the sub-topology, resource lock manager 144 can identify which are the additional affected resources and perform internal reservations of such additional resources. For example, resource lock manager 144 will assert exclusive locks against the requested resource and its descendants. This means that no other client can reserve these resources. Resource lock manager 144 will assert limited locks against the ancestor resources and associated resources. This means that other limited locks can be asserted against them, but no additional exclusive locks by other clients. Limited-to-exclusive lock promotion is allowed for the same client, but not for a different client.

Limited locks 208 allow some workflow operations to occur concurrently, which would not be possible if only exclusive locks were used or if the entire system was locked for each workflow. For example, assume one client requests creation of a cluster, while another client requests expansion, contraction, or deletion of another cluster (even in the same domain). Resource lock manager 144 asserts an exclusive lock on the cluster being added, but a limited lock on the domain of the cluster. Resource lock manager 144 allows the second client to modify/delete the other cluster in the same domain, since the domain only has a limited lock. In another example, assume one client requests creation of a workload domain while another client requests creation/deletion of a cluster in another workload domain. Resource lock manager 144 asserts an exclusive lock against the workload domain being created, but a limited lock on the system root. Resource lock manager 144 allows the second client to create/delete the other workload domain, since the system root only has a limited lock.

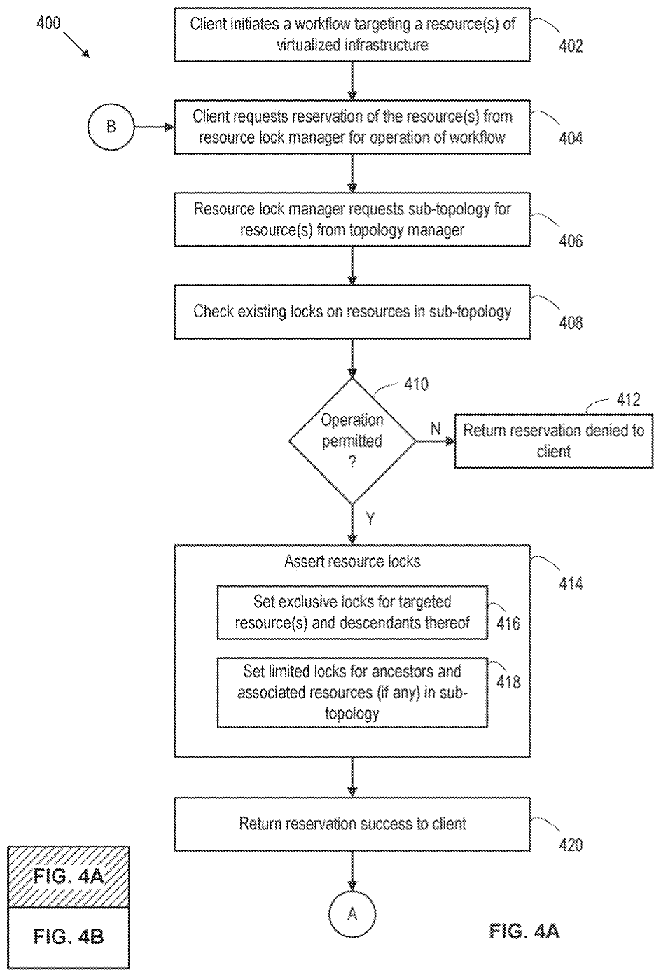

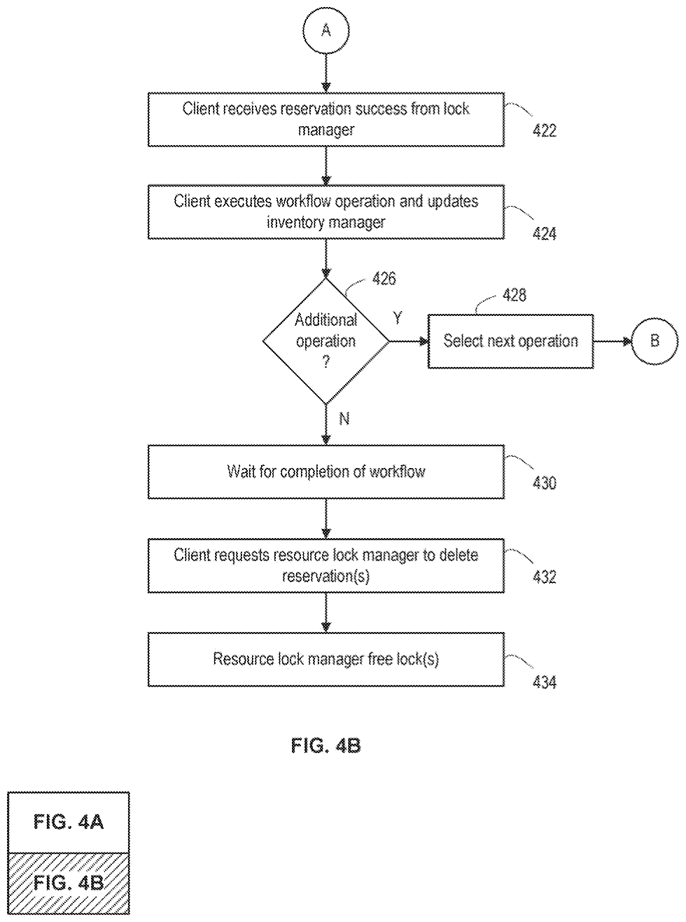

FIGS. 4A-B show a flow diagram depicting a method 400 of executing a workflow by a cloud management system according to an embodiment. Method 400 begins at step 402, where client 216 initiates workflow 212 targeting one or more resources of virtualized infrastructure 152. Workflow includes operation(s) 214 for creating, updating, deleting, or other mutative operation on resource(s). For example, domain manager 149 can initiate an add cluster workflow in response to a request by a user. At step 404, client 216 requests a reservation of the resource(s) from resource lock manager 144 for an operation 214 of workflow 212. For example, for an add cluster workflow, client 216 can request reservations for the constituent hosts of the new cluster.

At step 406, resource lock manager 144 requests a sub-topology for the target resource(s) from topology manager 145. For the add cluster example, resource lock manager 144 retrieves a sub-topology for each host in the new cluster. At step 408, resource lock manager 144 checks for existing locks on resources in the sub-topology. At step 410, resource lock manager 144 determines if the operation is permitted. The operation is not permitted if any target resource or descendants thereof, which are to receive an exclusive lock, already have a preexisting exclusive lock by another client. The operation is still permitted if ancestors and associated resources have preexisting limited locks by other client(s). The operation is not permitted if any ancestor or associated resource has an exclusive lock by another client. If the operation is not permitted, method 400 proceeds from step 410 to step 412, where resource lock manager 144 denies the reservation of the target resource(s) and notifies client 216. At this point, client 216 can suspend or terminate worktlow 212 and retry the reservation at another time. If the operation is permitted, method 400 proceeds to step 414.

At step 414, resource lock manager 144 asserts resource locks. This includes, at step 416, setting exclusive locks for the targeted resource(s) and descendants thereof. This further includes, at step 418, setting limited locks for ancestors and associated resources (if any) in the sub-topology. At step 420, resource lock manager 144 returns reservation success to the client. At step 410, resource lock manager 144 notifies client 216 that the requested reservation has been successful. Client 216 is only aware of the reservation against the targeted resource(s). In the add cluster example, resource lock manager 144 sets exclusive locks for the hosts of the new cluster and limited locks on ancestors of the host and associated resources (e.g., the domain having the hosts, the system root, the virtualization management server for the domain, the network manager for the domain).

At step 422, client 216 received the notification of successful reservation of the targeted resource(s). At step 424, client 216 executes operation 214 and updates inventory manager 148 (e.g., as to creation or deletion of resource(s)). In the add cluster example, client 216 cooperates with inventory manager 148 to create the cluster resource, create relationships between the cluster and the hosts, and create the relationship between the cluster and the domain. Note that execution of operation 214 can modify resource data 202 (e.g., as in the add cluster workflow), in which case inventory manager 148 notifies topology generator 146 as discussed above. Topology generator 146 then cooperates with topology manager 145 to update resource topology 204. In the add cluster example, resource topology includes the new cluster resource node and its host resource child nodes under the domain node.

At step 426, client 216 determines if there is any additional operation 214 of workflow 212 to be performed. If so, method 400 proceeds to step 428, where client 216 selects the next operation. Method 400 then proceeds back to step 404 and repeats. For example, in the add cluster workflow, domain manager 149 can perform additional cluster-level operation(s) for the new cluster. If at step 426 there are no more operations, method 400 proceeds to step 430, where client 216 waits for completion of workflow 212. At step 432, after workflow is completed, client 216 requests resource lock manager 144 to delete the reservation(s) of targeted resource(s). At step 434, resource lock manager 144 frees the exclusive and limited locks asserted during the operations of the workflow.

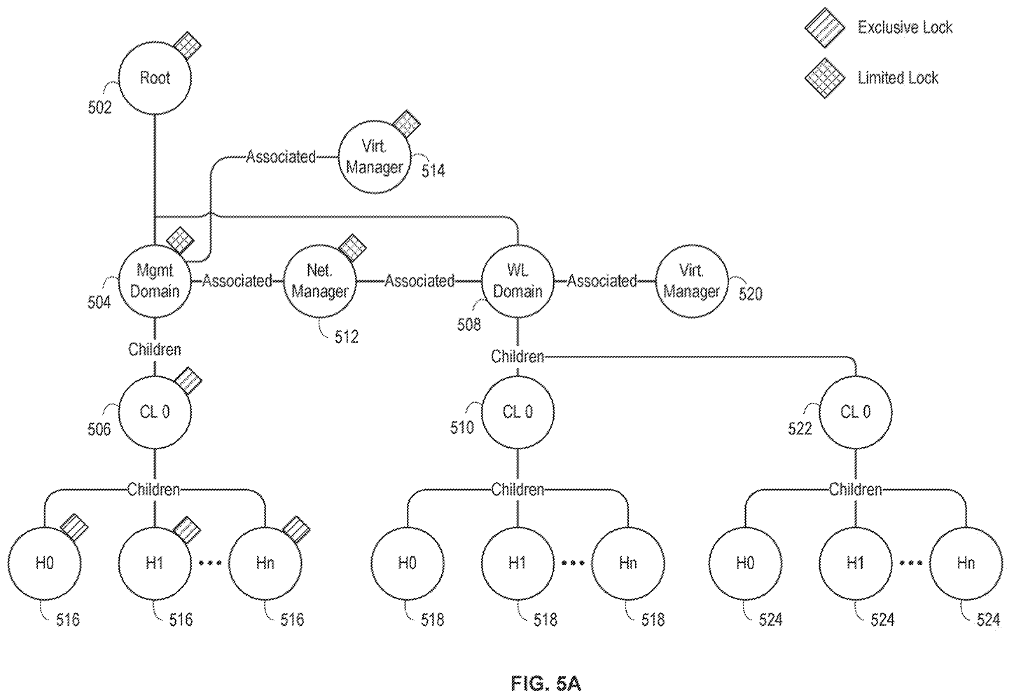

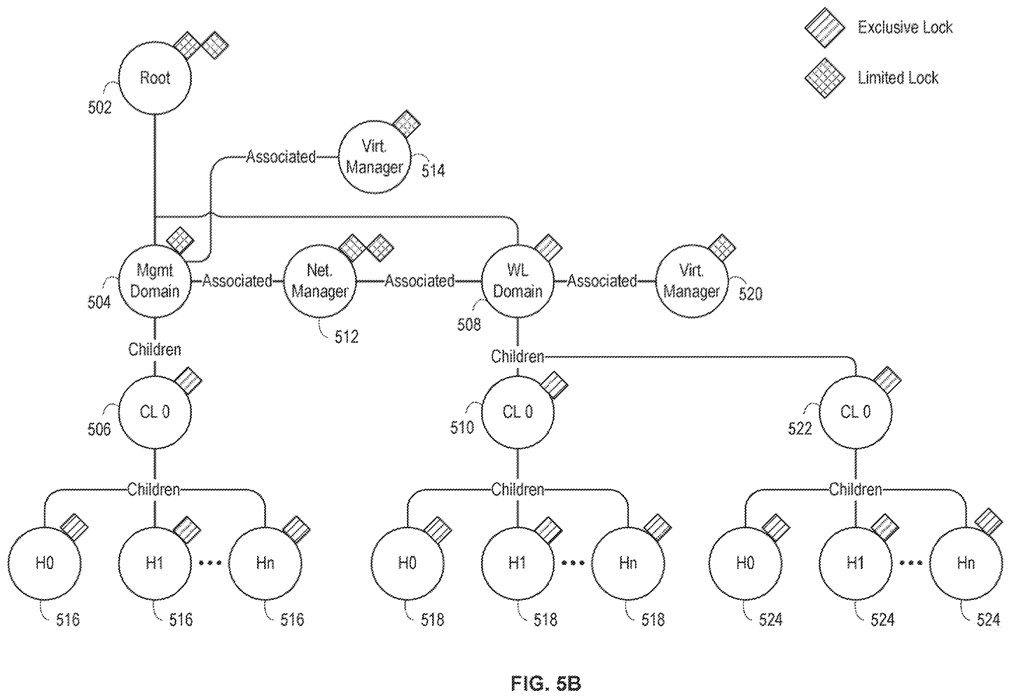

FIG. 5A is a block diagram depicting a resource topology during a workflow operation according to an embodiment. The resource topology includes a root 502. A management domain 504 and a workload domain 508 are children of root 502. A network manager 512 is associated with each of management domain 504 and workload domain 508. A virtualization manager 514 is associated with management domain 504 (e.g., a virtualization management server). A cluster 506 is a child of management domain 504. Hosts 516 are children of cluster 506. A virtualization manager 520 is associated with workload domain 508. Clusters 510 and 522 are children of workload domain 508. Hosts 518 are children of cluster 510. Hosts 524 are children of cluster 522.

Assume a client requests a reservation on cluster 506 (CL 0) in management domain 504. Assume there are no existing locks on any resources in the resource topology and that cluster 506 can be locked. In such case, resource lock manager 144 sets exclusive locks on cluster 506 and hosts 516, and limited locks on management domain 504, root 502, network manager 512, and virtualization manager 514.

FIG. 5B is a block diagram depicting the resource topology of FIG. 5A during two concurrent workflow operations according to an embodiment. The first operation of reserving cluster 506 is discussed above and results in the locks shown in FIG. 5A. Assume a client requests a reservation on workload domain 508. The sub-topology of workload domain 508 includes ancestor resource root 502 and associated resources network manager 512 and virtualization manager 520. Root 502 and network manager 512 have limited locks, not exclusive locks. Further, workload domain 508 has descendants cluster 510, cluster 522, hosts 518, and hosts 524. None of the descendants have locks. Finally, prior to the reservation request, workload domain 508 and virtualization manager 520 are not locks. Thus, resource lock manager 144 determines that the requested reservation of workload domain 508 can be granted. Resource lock manager 144 sets exclusive locks on workload domain 508 and its descendants, namely, clusters 510 and 522, and hosts 518 and 524. Resource lock manager 144 sets a limited lock on virtualization manager 520 associated with workload domain 508.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of reserving a resource of virtualized infrastructure in a data center on behalf of a client, the method comprising:
obtaining, by a resource lock manager from a topology manager, a sub-topology for the resource from a resource topology of the virtualized infrastructure;
setting, by the resource lock manager, an exclusive lock on the resource and on each of at least one descendant in the sub-topology for the resource, each exclusive lock disallowing any other lock on its respective resource;
setting, by the resource lock manager, a limited lock on each ancestor in the sub-topology for the resource, each limited lock allowing any other limited lock on its respective resource; and
notifying the client that a reservation of the resource is granted.

2. The method of claim 1, further comprising:
setting, by the resource lock manager, a limited lock on each associated resource in the sub-topology for the resource.

3. The method of claim 1, further comprising:
identifying, by the resource lock manager prior to the steps of setting, at least one preexisting lock in the sub-topology; and
performing the steps of setting and notifying in response to absence of any exclusive lock in the at least one preexisting lock.

4. The method of claim 3, further comprising:
performing the steps of setting and notifying in response to presence of at least one limited lock in the sub-topology.

5. The method of claim 1, wherein an inventory manager maintains resource data having tables that describe resources and relationships therebetween in the virtualized infrastructure, and wherein a topology generator receives notifications from the inventory manager in response to changes to the resource data.

6. The method of claim 5, wherein the topology generator updates the resource topology in response to the notifications from the inventory manager.

7. The method of claim 1, wherein the resource lock manager executes in a management domain, and wherein the virtualized infrastructure is divided between the management domain and at least one workload domain.

8. A method of executing a workflow on a resource of virtualized infrastructure in a data center on behalf of a client, the method comprising:
receiving, from the client at a resource lock manager, a request for a reservation of the resource;
setting, by the resource lock manager in response to the request, at least one exclusive lock and at least one limited lock on resources of the virtualized infrastructure, each exclusive lock disallowing any other lock on its respective resource, each limited lock allowing any other limited lock on its respective resource;
notifying, the client by the resource lock manager, that the reservation is granted;
executing, by the client, one or more operations of the workflow; and
removing, by the resource lock manager, the at least one exclusive lock and the at least one limited lock in response to a request for a release of the reservation of the resource.

9. The method of claim 8, wherein the step of setting the at least one exclusive lock and the at least one limited lock comprises:
obtaining, by the resource lock manager from a topology manager, a sub-topology for the resource from a resource topology of the virtualized infrastructure;
setting, by the resource lock manager, an exclusive lock on the resource and on each of at least one descendant in the sub-topology for the resource; and
setting, by the resource lock manager, a limited lock on each ancestor in the sub-topology for the resource.

10. The method of claim 9, wherein the step of setting the at least one exclusive lock and the at least one limited lock comprises:
setting, by the resource lock manager, a limited lock on each associated resource in the sub-topology for the resource.

11. The method of claim 8, further comprising:
identifying, by the resource lock manager prior to the steps of setting, at least one preexisting lock; and
performing the steps of setting, notifying, executing, and removing in response to absence of any exclusive lock in the at least one preexisting lock.

12. The method of claim 11, further comprising:
performing the steps of setting, notifying, executing, and removing in response to presence of at least one limited lock.

13. The method of claim 11, wherein an inventory manager maintains resource data having tables that describe resources and relationships therebetween in the virtualized infrastructure, and wherein a topology generator receives notifications from the inventory manager in response to changes to the resource data.

14. The method of claim 13, wherein the topology generator updates a resource topology used by the resource lock manager in response to the notifications from the inventory manager.

15. A virtualized computing system in a data center, comprising:
a hardware platform; and
a software platform, executing on the hardware platform, configured to reserve a resource of virtualized infrastructure in the data center on behalf of a client by:
obtaining, by a resource lock manager from a topology manager, a sub-topology for the resource from a resource topology of the virtualized infrastructure;
setting, by the resource lock manager, an exclusive lock on the resource and on each of at least one descendant in the sub-topology for the resource, each exclusive lock disallowing any other lock on its respective resource;
setting, by the resource lock manager, a limited lock on each ancestor in the sub-topology for the resource, each limited lock allowing any other limited lock on its respective resource; and
notifying the client that a reservation of the resource is granted.

16. The virtualized computing system of claim 15, wherein the software platform is further configured to:
set, by the resource lock manager, a limited lock on each associated resource in the sub-topology for the resource.

17. The virtualized computing system of claim 15, wherein the software platform is further configured to:
identify, by the resource lock manager prior to the steps of setting, at least one preexisting lock in the sub-topology; and
perform the setting and notifying in response to absence of any exclusive lock in the at least one preexisting lock.

18. The virtualized computing system of claim 17, wherein the software platform is further configured to:
perform the setting and notifying in response to presence of at least one limited lock in the sub-topology.

19. The virtualized computing system of claim 15, wherein an inventory manager maintains resource data having tables that describe resources and relationships therebetween in the virtualized infrastructure, and wherein a topology generator receives notifications from the inventory manager in response to changes to the resource data.

20. The virtualized computing system of claim 19, wherein the topology generator updates the resource topology in response to the notifications from the inventory manager.
